(19) United States
(12) Patent Application Publication
(10) Pub. No.: US 2015/0187221 A1
(43) Pub. Date: Jul. 2, 2015

(54) SYSTEMS AND METHODS FOR A SELF-DIRECTED WORKING MEMORY TASK FOR ENHANCED COGNITION

(71) Applicant: LUMOS LABS, INC., San Francisco, CA (US)

(72) Inventors: Tyler HINMAN, San Francisco, CA (US); Benjamin Lee AHRONI, San Francisco, CA (US); Aaron KALUSZKA, Hayward, CA (US)

(21) Appl. No.: 14/579,431

(22) Filed: Dec. 22, 2014

Related U.S. Application Data
(60) Provisional application No. 61/921,124, filed on Dec. 27, 2013.

(51) Int. Cl. G09B 5/02; G09B 19/00

(52) U.S. Cl. CPC G09B 5/02; G09B 19/00

(57) ABSTRACT

A computing device configurable to assess cognitive ability of a user operating a client computer/device by administering a training session. Tee training session includes presenting a plurality of unique items in a first trial wherein the user selects one unique item. Thereafter subsequent items are presented which include one or more previously selected items and a plurality of new unique items.

### CROSS-REFERENCE

This application claims the benefit of U.S. Provisional Application No. 61/921,124, filed Dec. 27, 2013, entitled “Systems and Methods for a Self-Directed Working Memory Task for Enhanced Cognition” by Hinman et al., which application is incorporated herein by reference.

### INTRODUCTION

Executive functions are cognitive processes that control other brain activities and are predominantly active in the prefrontal cortex in the brain. Executive functions underlie functions such as self-evaluation, planning, problem solving, controlling impulses and attention, and strategic selection and sequencing of behavior to reach desired goals.

Working memory is the ability to mentally operate on immediately available information while persisting this information for later potential encoding into long-term memory. A considerable body of neuroscience research relates working memory capacity to other cognitive abilities such as fluid intelligence. Individuals with strong working memory capacities are more likely to succeed in education and professional environments. Enhancing this capacity is highly desirable.

Researchers have used complex working memory tasks to measure and train the domain-general memory capacity. However, these tasks typically involve separate items for retrieval and processing (e.g., solve a math problem while remembering an unrelated number or remembering the locations of objects in the order of the numbers printed on them). These designs lack ecological validity, in that most real world tasks involving memory and control of attention involve operating on the same items that are to be remembered. Organic uses of complex working memory like this activate prefrontal cortex in a robust and ecologically relevant manner. They also have the advantage of being relatively easy tasks to understand, unlike the unnatural operations in most complex working memory tasks.

There have been a number of attempts to develop programs to enhance working memory capacity. For example, Cogmed Inc. has developed several variants of working memory training aimed at enhancing cognition in children with a particular focus on reducing the burden of attention deficit hyperactivity disorder (ADHD). See, KLINGBERG, et al., Journal of Clinical and Experimental Neuropsychology 24 (6 )2002. Jaeggi and colleagues have shown that training on a challenging working memory task—called the dual n-back—improves users' performance on measures of fluid intelligence. See, JAEGGI, “Improving fluid intelligence with training on working memory,” Proc. Nat'l Acad. Sci., 105 (19 ): 6829-6833 (2008). These promising approaches demonstrate the appeal of working memory training; however, they are not without their limitations. Most working memory tasks do not engage a user's decision-making process. One exception is known as the self-ordered pointing task, a task in which users choose which objects to remember. See, PETRIDES, “Deficits on subject-ordered tasks after frontal-and temporal-lobe lesions in man,” Neuropsychologia, 20:249-262(1982).

Beyond working memory, performance on the self-ordered pointing task has been found to correlate with measures of sorting and set shifting, verbal learning, visuospatial ability, strategy utilization, and planning See, ROSS, et al., “The reliability and validity of the self-ordered pointing task, ” Arch. Clin. Neuropsychology. 22(4) 449-458(2007); and HONGWANISHKUL, et al., “Assessment of hot and cool executive function in young children: age-related changes and individual differences,” Dev. Neuropsych. 28(2). 617-44(2005). However, the traditional self-ordered pointing task is of limited use in cognitive training due to the limited number of items that users must remember.

### SUMMARY OF THE INVENTION

Disclosed are cognitive training exercises capable of training working memory systems of a user in an intuitive, engaging, and adaptively challenging way to enhance cognition. The exercises engage users in tasks where the user identifies an object not previously chosen. As users progress through sequential rounds, difficulty of the training is increased by decreasing the uniqueness of objects. Decreasing the number of unique objects results in fewer and fewer unique objects being presented to the user on the user interface display. Increasing the number of unique objects results in more and more unique objects being presented to the user on the user interface display. Each of the objects presented during the training exercise has one or more unique characteristics such that each item presented is unique. Unique objects can be presented more than once during the training exercise and can have some overlapping features while still being unique.

Cognitive training exercises are administered to a user by a computing device in one or more use sessions which train the working memory of the user, the training exercises are configurable to dynamically train the working memory of the user. Additionally, the complexity of future exercises administered to a user are dynamically adjusted which allows the system to improve assessment and training of the working memory of a user.

An aspect of the disclosure is directed to a method of enhancing a cognitive ability of a user. Suitable methods comprise the steps of: conducting, via a user interface display of a user computing device, a training session comprising: presenting, via the user interface display of the user computing device, a first plurality of unique items; allowing the user, via the user interface display of the user computing device, to select one of the first plurality of unique items presented; presenting, via the user interface display of the user computing device, a subsequent plurality of items wherein at least one previously selected item is presented along with at least one or one or more subsequent unique items; allowing the user, via the user interface display of the user computing device, to select one of the subsequent plurality of items presented; and providing feedback to the user, via the user interface display of the user computing device. In some configurations, the feedback is correct when one of the at least one or one or more subsequent unique items is selected by the user from the subsequent plurality of items. As will be appreciated by those of skill in the art, no upper limit of unique items presented at any time need be present. However, a plurality of items presented can be two or more items, three or more items, four or more items, five or more, six or more, and so on. Additionally, the number of unique items can decrease over the performance of an exercise to accommodate, for example, space on the visual display to place an item, etc. Thus, for example, where a user is approaching an end to a perfect game the number of unique items could be two or one. Additionally, the feedback is incorrect when the item selected is one of a previously selected item. The method can also comprise: repeating the steps of presenting the subsequent plurality of items, allowing the user to select one of the subsequent plurality of items, and providing a feedback to the user. In at least some configurations, the first plurality of unique items is three unique items. Other numbers of unique items can be presented at each stage without departing from the scope of the disclosure. Once presented, in some configurations, unselected unique items are place into a queue. Placement in the queue can be serial placement or random placement. A complexity of the training session can be determinable by the user computing device evaluating a number of times a subsequent plurality of unique items is presented to the user via the user interface display of the user computing device. Additionally, in some at least configurations, increasing or decreasing, via the user computing device, a complexity of the training session according to a user performance during the training session.

Another aspect of the disclosure is directed to an apparatus for enhancing a cognitive ability of a user which comprises: a user computing device configured to: conduct a training session, utilizing a user interface display of the user computing device, comprising: presenting, via the user interface display of the user computing device, a first plurality of unique items; allowing the user, via the user interface display of the user computing device, to select one of the first plurality of unique items presented; presenting, via the user interface display of the user computing device, a subsequent plurality of unique items wherein at least the selected item is presented; allowing the user, via the user interface display of the user computing device, to select one of the subsequent plurality of unique items presented; and providing feedback to the user, via the user interface display of the user computing device. In some configurations, the feedback is correct when one of the at least one or one or more subsequent unique items is selected by the user from the subsequent plurality of items. Additionally, the feedback is incorrect when the item selected is one of a previously selected item. The apparatus can also be configured to: repeating the steps of presenting the subsequent plurality of items, allowing the user to select one of the subsequent plurality of items, and providing a feedback to the user. In at least some configurations, the first plurality of unique items is three unique items. Other numbers of unique items can be presented at each stage without departing from the scope of the disclosure. Once presented, in some configurations, unselected unique items are place into a queue. Placement in the queue can be serial placement or random placement. A complexity of the training session can be determinable by the user computing device evaluating a number of times a subsequent plurality of unique items is presented to the user via the user interface display of the user computing device. Additionally, in some at least configurations, increasing or decreasing, via the user computing device, a complexity of the training session according to a user performance during the training session.

Still other aspects of the disclosure are directed to a non-transitory computer readable storage medium tangibly storing computer program instructions capable of being executed by a computer processor, the computer program instructions defining a method comprising: determining, by the processor, a training session to assess cognitive ability of a user operating a client device, the cognitive ability assessment comprising presenting, via the user interface display of the user computing device, a first plurality of unique items; allowing the user, via the user interface display of the user computing device, to select one of the first plurality of unique items presented; presenting, via the user interface display of the user computing device, a subsequent plurality of unique items wherein at least the selected item is presented; allowing the user, via the user interface display of the user computing device, to select one of the subsequent plurality of unique items presented; and providing feedback to the user, via the user interface display of the user computing device.

Yet another aspect of the disclosure are directed to a non-transitory computer readable storage medium tangibly storing computer program instructions capable of being executed by a computer processor, the computer program instructions defining a method comprising: determining, by the processor, a training session to assess cognitive ability of a user operating a client device, the cognitive ability assessment comprising transmitting, by the processor to the client device, a selection from the plurality of unique items; receiving, by the processor and from the user via the client device, the selected unique items; determining, by the processor, whether the selected unique item is the same as a previously selected unique item; and transmitting, by the processor to the client device, an indication as to whether the selection is correct.

Additionally, the disclosure is directed to an apparatus for enhancing a cognitive ability of a user, comprising: a user computing device means including a means for conduct a training session, utilizing a user interface display means of the user computing device means, comprising: the user computing device means including a means for presenting on the user interface display means a first plurality of unique items, the user interface display means further comprising a means for displaying to the user a subsequent plurality of unique items wherein at least a selected item from the first plurality of unique items is presented; the user computing device means including a means for allowing the user, utilizing the user interface display means to select one of the subsequent items. In some configurations the user feedback is correct when one of the at least one or one or more subsequent unique items is selected by the user from the subsequent plurality of items. Additionally, the feedback is incorrect when the item selected is one of a previously selected item. Additionally, aspects of the disclosure include the steps of repeating the steps of presenting the subsequent plurality of unique items, allowing the user to select one of the subsequent plurality of unique items, and providing feedback to the user. In at least some configurations, the first plurality of unique items is three unique items. Additionally, unselected unique items can be placed at any position within a queue of items to be presented. A complexity of the training session is determined by the user computing device from a number of times the subsequent plurality of unique items is not equal to the unique item selected from the first plurality of unique items. The complexity of the training can be increased or decreased, via the user computing device means, the complexity of the training session according to a user performance during the training session.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a screen shot illustrating three unique objects displayed by a computing device, any of which can be chosen by a user;

FIG. 2 is a screen shot illustrating a displayed game board being cleared and an introduction of a next trial;

FIG. 3 is a screen shot illustrating a trial wherein a previously selected object (turtle) is presented in addition to one or more new objects;

FIG. 4 is a screen shot illustrating a trial from the same round as shown in FIG. 2, wherein at the screen of FIG. 3, a user had chosen a sand dollar, thus the previously selected turtle and currently selected sand dollar stay on the screen along with new previously unselected items;

FIG. 5 is a screen shot illustrating a trial from the same round as shown in FIGS, 2-4, wherein the user has the previously selected sand dollar, which is shown with an incorrect marker because it was previously chose, and wherein the correct available answers (shell, pail and sail boat) are visually distinguished, e.g., by outlining or highlighting;

FIG. 6 is a screen shot illustrating a results screen indicating a number of correct objects chosen and scoring;

FIG. 7 is a screen shot illustrating a reminder that can appear between rounds;

FIG. 8 illustrates a game flow diagram executable by a computing device;

FIG. 9 is a screen shot illustrating with a plurality of objects;

FIG. 10 illustrates a flow diagram executable by a computing device directing players to play the tutorial;

FIG. 11 illustrates a tutorial flow diagram executable by a computing device;

FIGS. 12A-B illustrate screen shots wherein a tutorial describes a method of interaction through a series of prompts;

FIGS. 13A-B illustrate screen shots of a tutorial providing interactive feedback;

FIG. 14 illustrates a screen shot wherein the tutorial ends by describing the game's strategy;

FIG. 15 illustrates a heads-up display displayable on a screen indicating a current round, score and number correct; and

FIG. 16 illustrates a screen shot of a final results screen.

### DETAILED DESCRIPTION OF THE INVENTION

An aspect of the disclosed exercises provide a gameplay mechanism wherein a user operating a computing device selects an object displayed on a computer screen associated with the computing device that has not been previously selected from ever-growing sets of objects. In an implementation, the objects are represented as items that may be found on a beach or along a seashore, though a variety of other physical representations could be substituted. From the chosen set of objects, some objects are drawn from a larger set. This selection could be random or ordered based on previous trials to encourage or discourage memory interference. To begin a trial, a plurality of unique objects (e.g., three in this illustration) are generated by the computing device and presented to the user on a display. The plurality of unique objects can be presented at random locations on the screen. These unique objects can, for example, appear on an orthogonal grid in some implementations. In other implementations the layout of the unique objects on the screen is not limited to a grid. Additionally, or in an alternative embodiment, the unique objects can be presented at one or more spatial orientations to encourage users to remember the general shape and features of the object. The spatial orientation of a unique object at a first visual presentation can vary from the spatial orientation at a second or subsequent visual presentation.

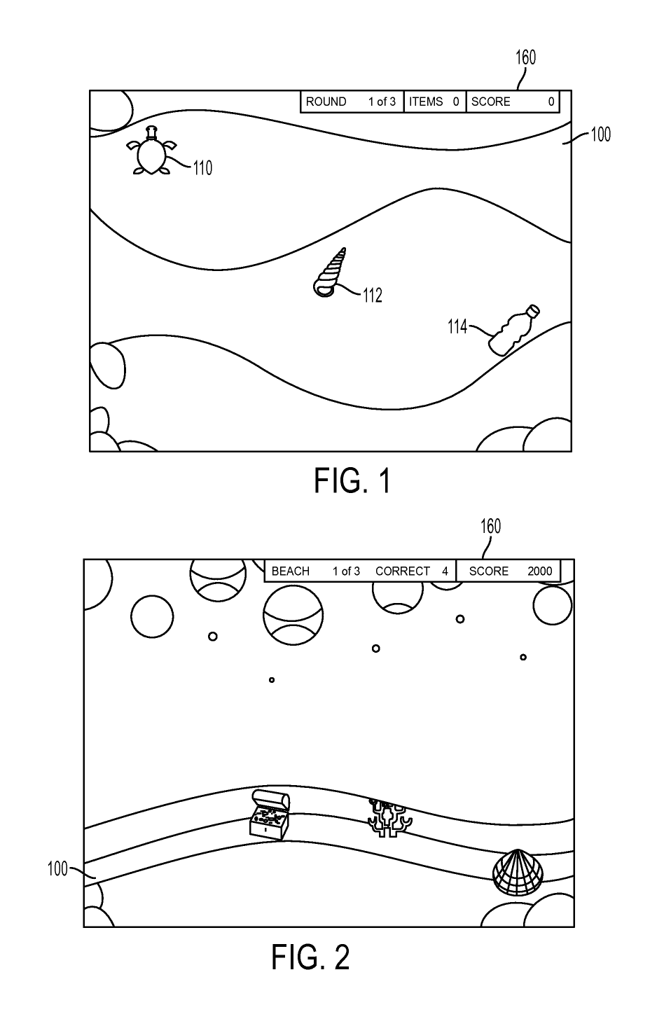

As shown in FIG. 1, a screen 100 is illustrated which has three unique objects, a first object 110 which is a turtle, a second object 112 which is an elongated shell, a third object 114 which is a bottle. Thematically, the objects presented can have a similar characteristic such as “objects you might find along the shore.” In a first trial, a user is encouraged to select an object is presented on a computing device screen interface (all are correct answers in the first trial and the user may choose any one). Objects can be selected, for example, by pointing and clicking the desired location with a computer mouse or other pointing device in 2D or 3D space, by touching the location desired on a touch-sensitive input device, or by voice command. A heads-up score display 160 can be provided on screen which provides feedback to the user on the round of gameplay, the number of items selected, and the score.

After the user selects a first unique object, the grid or screen of objects (such as shown in FIG. 1) is briefly obscured (for example, by an image such as an ocean wave washing in and out, as shown in FIG. 2. A next screen is presented. In each subsequent screen, one or more previously selected items is presented to the user via the computing device screen interface along with one or more new and unique items. In some configurations, a number of unselected objects can be removed. For example, one less item than the number of new objects are added to the overall set of unselected objects. In some configurations, removed items are placed at the back of a queue of items to be presented. In other configurations, the removed items are placed randomly in the queue for future presentation. Multiple new objects are chosen from the overall set of unselected objects, e.g. from the front of the queue in an implementation, and presented to the user with the previously selected item.

In some configurations, three new items are presented with one or more of the previously presented and chosen item, although more or fewer can be provided without departing from the scope of the disclosure. Additionally, as discussed above, the new items could be chosen randomly, along with the user's chosen object.

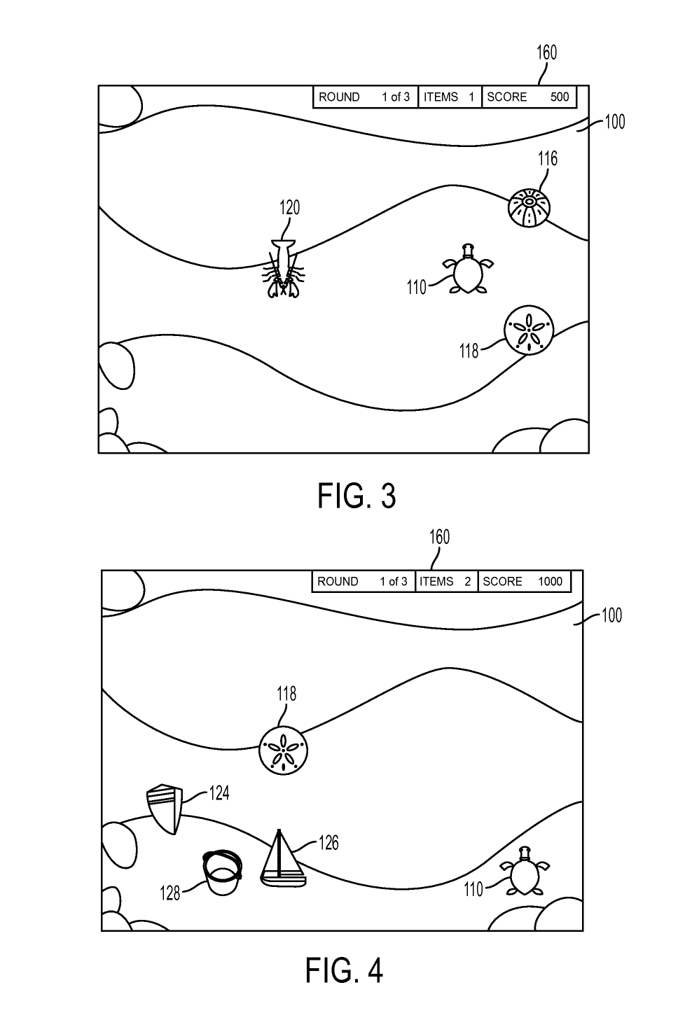

Thus, from the screen presented to the user in FIG. 1, three unique items are shown. If the user selects the first unique item 110, the turtle, the next screen presented to the user after the screen is cleared (represented in FIG. 2) includes the first unique item selected 110, the turtle, along with three new unique items 116, 118, 120, represented by a lobster, a sand dollar, and a sponge as shown in FIG. 3. The two remaining unique items 112, 114 from the first screen in FIG. 1 are not necessarily presented in FIG. 3. Instead, the remaining unique items 112, 114 can be moved to a position later in a queue of unique items to be presented during the game. These unique objects or items can be placed randomly by the computing device on a grid presented on a user's computing device screen. The user can then select any object shown in FIG. 3 that has not been previously selected by the user. If a correct choice is made by the user, the computing device causes play to proceed in the same fashion through additional screens with new unique items being presented and previously un-selected new items being temporarily returned to a queue.

In this case, as shown in FIG. 4, the correct but unselected objects from FIG. 3 (i.e., items 116, 120) are removed and placed in the queue the selected objects 110, 118 are presented in FIG. 4 along with three new unique items 124, 126, 128 represented by a conch shell, a sailboat and a pail. In an implementation, the number of objects presented can increase by one unique item with each correct response from the user. Additional objects, either unique or not unique, could be introduced as well without departing from the scope of the disclosure. Additionally, limits may be placed on the overall set of objects available to be presented by the computing device on a user's screen as well as the number of simultaneously displayed objects in order to account for screen space. Thus, a subset of previously selected objects can be presented provided at least one unique objected presented is a previously selected object after the first trial. Previously presented and selected items can be positioned in the same location during subsequent trials, or in different locations on the screen from one or more prior locations.

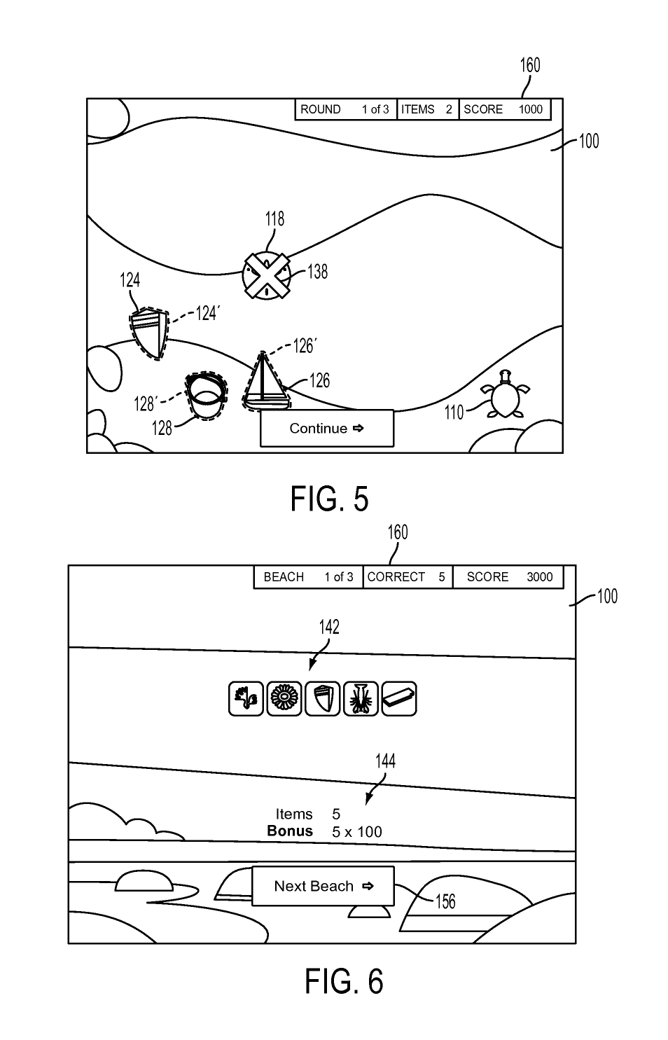

In the event of an incorrect answer by the user, an indicator 138 is displayed over the selected incorrect items (for example, a red “X”) and the correct answers are highlighted. As shown in FIG. 5, sand dollar 118 was selected, which was previously selected at FIG. 3. When the sand dollar is selected again an “x” 138 appears over the item to provide feedback to the user that a previously selected item has been selected. The available correct unique items 124, 126, 128 represented by a conch shell, a sailboat and a pail can be presented with a visual feature such as highlighting 124′, 126′, 128′ around each item to provide feedback to the user as to the correct and available unique items that could have been selected. In an implementation, this action ends the trial, however, in other implementations, the user could be allowed to make multiple mistakes before the trial ends.

A summary can be presented to the user as shown in FIG. 6. The summary screen 100 provides a catalog 142 of correctly identified unique items, a number of items correctly selected 144, a bonus points indicator, and an advance button 156 which allows the user to elect to advance to the next game. Additionally, a heads-up status bar can be provided which identifies the number of games in the series (e.g., Beach 1 of 3), the number of correct responses, and a total score.

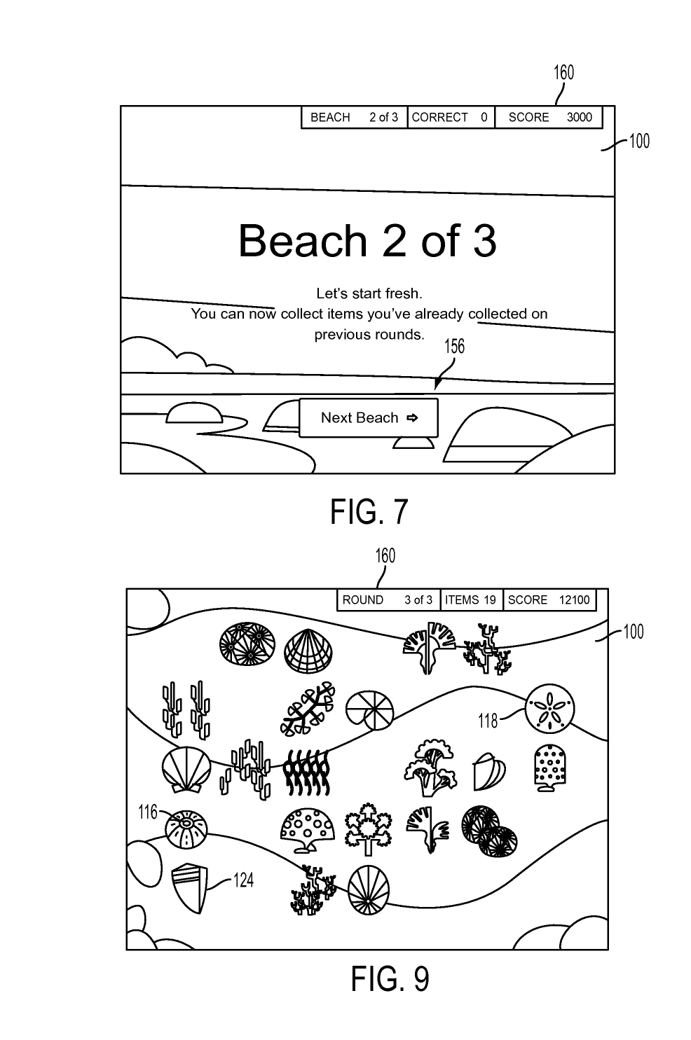

Turning to FIG. 7, when a user progresses to the next game in the series (e.g., beach 2 of 3 beaches), a screen 100 is presented by the computing device on the screen with instructions such as “Let's start fresh. You can now collect items you've already collected on previous rounds.” An advance button 156 is provided which, when activated by the user, causes the computing device to begin the next round of the game. Each round is configurable to begin with a clean slate; that is, the previous round's selections do not factor into the new round within a game and every object presented in the current round is considered newly presented until such time as it is selected in the current round.

Several rounds may be played in a single game session or user session in order to extend the exercise and modulate difficulty. As shown in FIG. 9, a variety of unique items can be presented to a user. FIG. 9 illustrates 22 unique items available for presentation to a user during a trial. Each of the screens can provide a heads-up display 160 which summarizes the status of the game at a given time.

In an implementation, the user progresses through three rounds. With each subsequent round, the shapes of unique objects available to be visually presented on the screen in a set become more similar and abstract, making it more difficult for the player to label, compartmentalize, and memorize the chosen objects. For example, in an implementation, a first level includes three distinct objects as shown in FIG. 1, such as a turtle, lobster, and bottle. These three distinct objects are quite different making it easier for a user to re call which object was chosen. In a later level, the objects presented can be restricted to various types of shells and seaweed as shown in FIG. 9. Although still unique, objects presented in subsequent rounds could be taken from the set used in previous rounds in order to train memory interference or “forgetting,” or they may be entirely different. Other features, such as color or orientation, could be used as distinguishing factors or interfering factors.

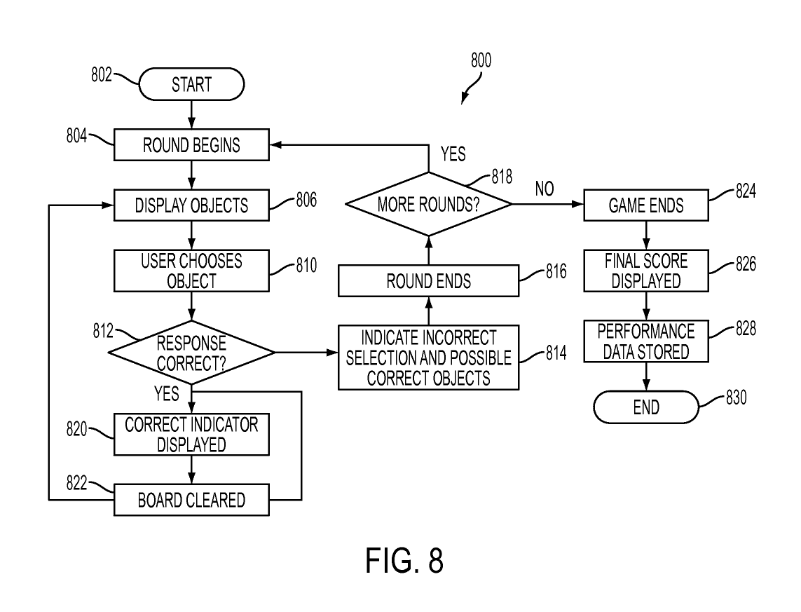

FIG. 8 illustrates a game flow 800 administered by a computing device and delivered to a user by a computing device interface, such as a screen. The game flow starts 802. Once the game flow starts 802, a round for a user to play begins 804. Objects are displayed by the screen associated with the computing device 806. The user then chooses an object 810. Once an object is chosen, the computing device determines if the user selection is a correct choice 812. If the user selection is not a correct choice then the computing device generates a display to indicate an incorrect selection (such as an X) and possible correct choices (such as highlighting) 814. After the feedback is provided, the round ends 816 and the computing device determines if additional rounds are to be presented 818. If additional rounds are to be presented, then a new round begins 804. If additional rounds are not to be presented, then the game ends 824, the user is presented by the computing device with a final score 826 , and additional performance data is stored by the system 828 and the game ends 830. If the response is correct, then a correct indicator may be displayed 822. Regardless of whether the correct indicator is displayed, the board is cleared 822 and a new set of objects is displayed 806. As discussed previously, the new set of objects includes one or more previously selected unique objects and one or more previously un-selected unique objects.

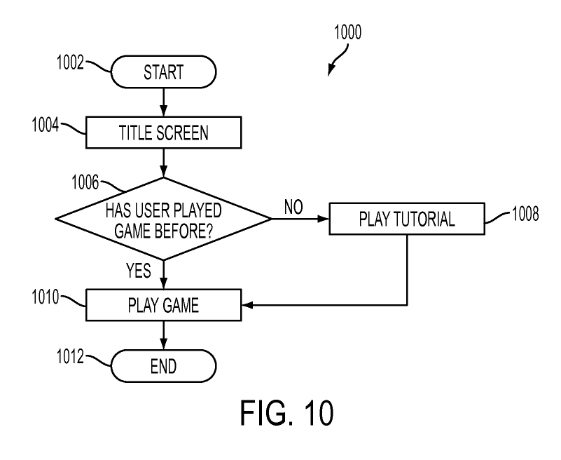

The user can be introduced to the training exercise via a short interactive tutorial describing the gameplay elements. As shown in FIG. 10, a tutorial flow 1000 is illustrated. The tutorial starts 1002, after which a title screen is presented by the computing device on the screen to the user 1004. The computing device determines whether the user has played the game before 1006. If the user has not played the game before, then a tutorial is played 1008. If the user has played before, then the game is started 1010 and the tutorial flow ends 1012. As will be appreciated by those skilled in the art, even where a user has played the game previously, the user can elect to view the tutorial again.

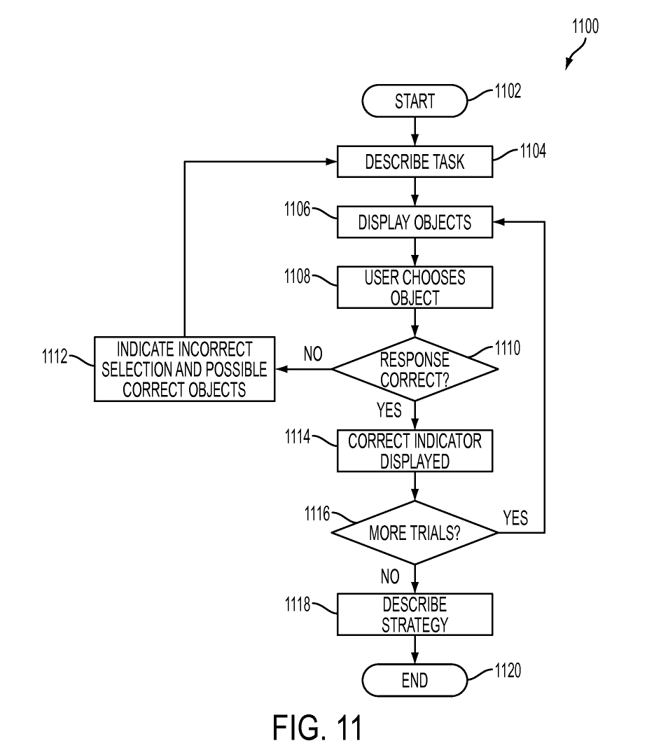

Another tutorial flow 1100 is shown in FIG. 11. The flow starts 1102, after which a task is described 1104. Once the task is described and objects are displayed 1106. The user then chooses on object 1108. Next the system determines whether the response is correct 1110. If the answer is not correct 1112, an incorrect indicator can be displayed along with the possible correct objects then the task is described again 1104, and the process repeats. If the response is correct 1114, then a correct indicator can be displayed followed by more trials 1116. If more trials are to be displayed, then objects are displayed 1106 and the process repeats. If no more trials are desired, then the strategy can be described 1118 after which the tutorial ends 1120.

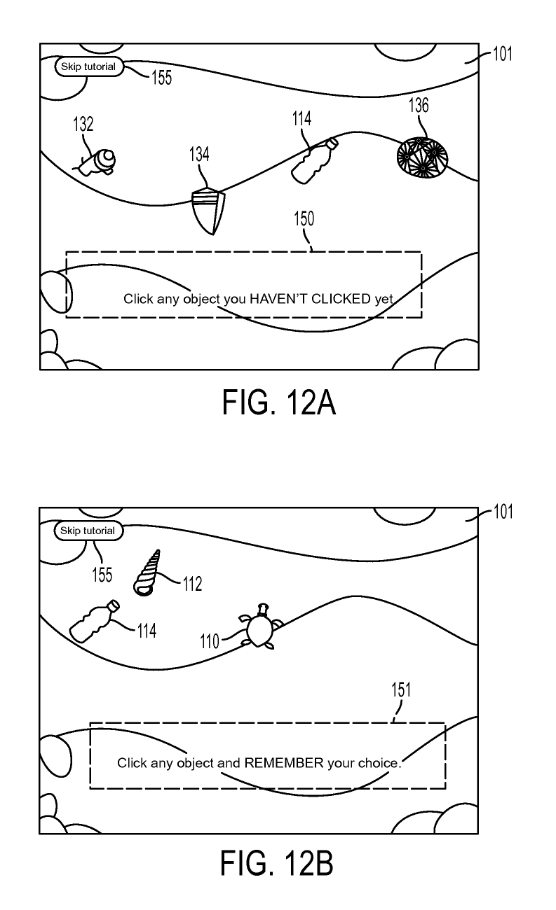

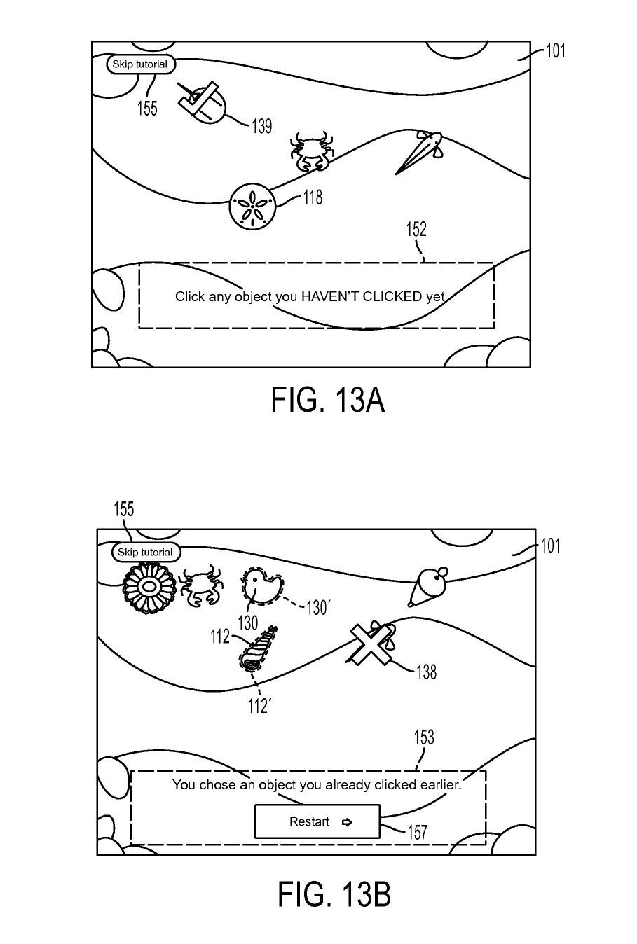

FIGS. 12A-B illustrate two tutorial screens 101. Unique items are presented 114, 132, 134, 136 along with a first instruction 150. The first instruction 150 can be, for example, “Click any object you HAVEN'T CLICKED yet.” At any time the user can skip the tutorial by clicking the skip button 155. As shown in FIG. 12B a different set of unique items are displayed 110, 112, 114. Another set of instructions 151 can be presented such as “Click any object and REMEMBER your choice.” Thus, the tutorial can also be configurable to prompt the user to complete a series of simple game configurations with guided messages and prompts as shown in FIGS. 12A-B. Important gameplay features such as how to select an item and the self-directed nature of the task are explained with animations. Interactive feedback can be provided which informs users of their success in understanding the task, and players are given the chance to retry after performing the base task incorrectly as shown in FIGS. 13A-B. Unique items 118, and others can be presented. Instructions 152 can be provided, such as “Click any object you HAVEN'T CLICKED yet.” If the correct item is selected, then a correct item selected feedback 139 is displayed to the user. If an incorrect item is selected, then an incorrect item selected feedback 138 is displayed to the user along with highlighting 130′, 112′ around items that were not previously selected and could have been selected by the user. Additional instructions 153 can be provided, such as “You chose an object you already clicked earlier.” At any time, the user can choose to skip the tutorial by clicking the skip tutorial button 155. Once the training is complete, the user can restart the training by selecting the restart button 157.

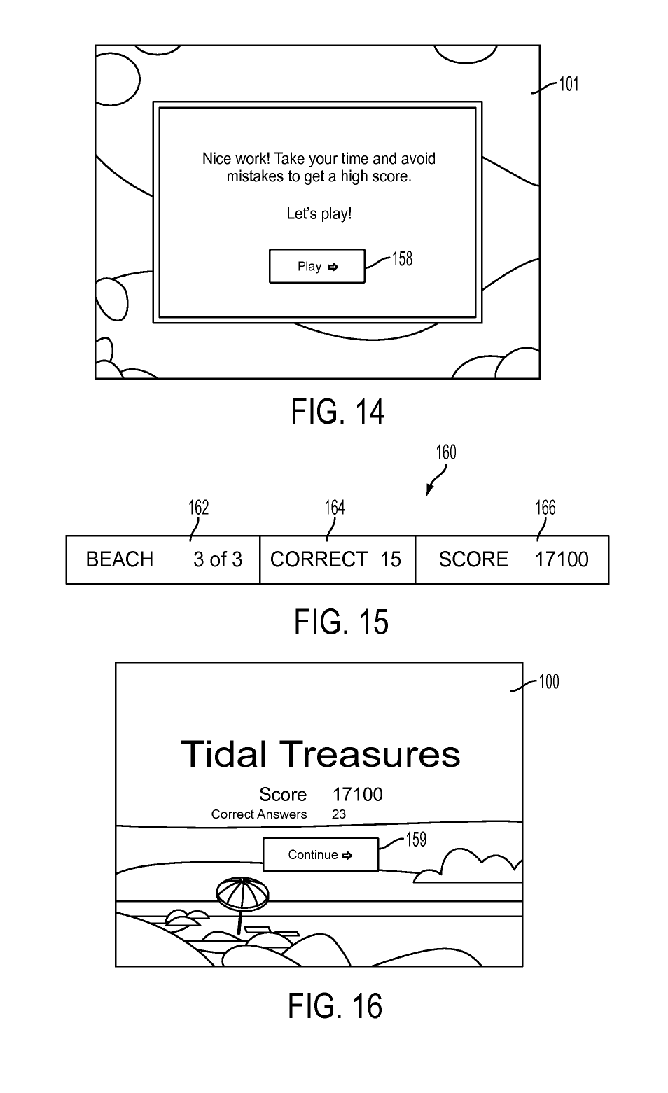

After a number of successful trials in the tutorial, the system presents the player with a screen 1010 that invites the user to start the game as shown in FIG. 14. The user can then select a play button 158 presented by the system on the screen. The tutorial may be recalled in the future if a player needs to be reminded how to play and/or dismissed if not needed.

Progress such as the number of correct objects selected and round number is displayed unobtrusively to the user during trials using a heads-up display 160 shown in FIG. 15. The heads-up display 160 can present real-time feedback on the status of the game by displaying, for example, which trial is in process 162 (such as “Beach 3 of 3” where a total number of trials completed vs. a total number of trials available for completion in a gameplay is presented, a total number of correct selections 164, and a total score 166. At the end of each session, a results screen 100 is displayed, which indicates score alongside the number of objects correctly selected FIG. 16, which can include a continue button 159.

In engaging the systems and methods according to aspects of the disclosed subject matter the user may engage in one or more use sessions. Each use session may include a training session and/or one or more rounds of gameplay. Each gameplay may include one or more trials, where each trial is represented, for example, by a beach. As illustrated above, for example, each gameplay consists of three trials. For each use session involving a gameplay, performance data for the user for each gameplay and each use session is stored. Performance data may be compared from one or more use sessions, gameplays, or trials within a gameplay to determine a difficulty level of a future trial or gameplay. The difficulty level may be determined real-time at the completion of a session, a round of gameplay, or at the commencement of a session or a round of gameplay.

The systems and methods according to aspects of the disclosed subject matter may utilize a variety of computer and computing systems, communications devices, networks and/or digital/logic devices for operation. Each may, in turn, be configurable to utilize a suitable computing device which can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as a BlackBerry®, iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web-browser, e.g., to provide access to applications and data and other content located on a web-site or a web-page of a web-site.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method which may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at some times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of enhancing a cognitive ability of a user, comprising:
conducting, via a user interface display of a user computing device, a training session comprising:
a) presenting, via the user interface display of the user computing device, a first plurality of unique items;
b) allowing the user, via the user interface display of the user computing device, to select one of the first plurality of unique items presented;
c) presenting, via the user interface display of the user computing device, a subsequent plurality of items wherein at least one previously selected item is presented along with one or more subsequent unique items;
d) allowing the user, via the user interface display of the user computing device, to select one of the subsequent plurality of items presented; and
e) providing feedback to the user, via the user interface display of the user computing device.

2. The method of claim 1 wherein the feedback is correct when one of the one or more subsequent unique items is selected by the user from the subsequent plurality of items.

3. The method of claim 1 wherein the feedback is incorrect when the item selected is one of a previously selected item.

4. The method of claim 1 further comprising:
repeating the steps of presenting the subsequent plurality of items, allowing the user to select one of the subsequent plurality of items, and providing a feedback to the user.

5. The method of claim 1 wherein the first plurality of unique items is three unique items.

6. The method of claim 1 further comprising the step of placing unselected unique items into a queue.

7. The method of claim 4 wherein a complexity of the training session is determined by the user computing device from a number of times a subsequent plurality of unique items is presented to the user via the user interface display of the user computing device.

8. The method of claim 4 further comprising:
increasing or decreasing, via the user computing device, a complexity of the training session according to a user performance during the training session.

9. An apparatus for enhancing a cognitive ability of a user, comprising:
a user computing device configured to:
conduct a training session, utilizing a user interface display of the user computing device, comprising:
a) presenting, via the user interface display of the user computing device, a first plurality of unique items;
b) allowing the user, via the user interface display of the user computing device, to select one of the first plurality of unique items presented;
c) presenting, via the user interface display of the user computing device, a subsequent plurality of unique items wherein at least the selected item is presented;
d) allowing the user, via the user interface display of the user computing device, to select one of the subsequent plurality of unique items presented; and
e) providing feedback to the user, via the user interface display of the user computing device.

10. The apparatus of claim 9 wherein the feedback is correct when one of the one or more subsequent unique items is selected by the user from the subsequent plurality of items.

11. The apparatus of claim 9 wherein the feedback is incorrect when the item selected is one of a previously selected item.

12. The apparatus of claim 9 further comprising:
repeating the steps of presenting the subsequent plurality of unique items, allowing the user to select one of the subsequent plurality of unique items, and providing a feedback to the user.

13. The apparatus of claim 12 wherein the first plurality of unique items is three unique items.

14. The apparatus of claim 9 further comprising the step of placing unselected unique items into a queue.

15. The apparatus of claim 12 wherein a complexity of the training session is determined by the user computing device from a number of times a subsequent plurality of unique items is presented to the user via the user interface display of the user computing device.

16. The apparatus of claim 12 further comprising:
increasing or decreasing, via the user computing device, a complexity of the training session according to a user performance during the training session.

17. A non-transitory computer readable storage medium tangibly storing computer program instructions capable of being executed by a computer processor, the computer program instructions defining a method comprising:
determining, by the processor, a training session to assess cognitive ability of a user operating a client device, the cognitive ability assessment comprising presenting, via the user interface display of the user computing device, a first plurality of unique items;
allowing the user, via the user interface display of the user computing device, to select one of the first plurality of unique items presented;
presenting, via the user interface display of the user computing device, a subsequent plurality of unique items wherein at least the selected item is presented;
allowing the user, via the user interface display of the user computing device, to select one of the subsequent plurality of unique items presented; and
providing feedback to the user, via the user interface display of the user computing device.

18. An apparatus for enhancing a cognitive ability of a user, comprising:
a user computing device means including a means for conduct a training session, utilizing a user interface display means of the user computing device means, comprising:
the user computing device means including a means for presenting on the user interface display means a first plurality of unique items,
the user interface display means further comprising a means for displaying to the user a subsequent plurality of unique items wherein at least a selected item from the first plurality of unique items is presented;
the user computing device means including a means for allowing the user, utilizing the user interface display means to select one of the subsequent items.

19. The apparatus of claim 18 wherein the feedback is correct when one of the one or more subsequent unique items is selected by the user from the subsequent plurality of items.

20. The apparatus of claim 18 wherein the feedback is incorrect when the item selected is one of a previously selected item.

21. The apparatus of claim 18 further comprising:
repeating the steps of presenting the subsequent plurality of unique items, allowing the user to select one of the subsequent plurality of unique items, and providing feedback to the user.

22. The apparatus of claim 18 wherein the first plurality of unique items is three unique items.

23. The apparatus of claim 18 further comprising the step of placing unselected unique items into a queue.

24. The apparatus of claim 21 wherein a complexity of the training session is determined by the user computing device means from a number of times the subsequent plurality of unique items is not equal to the unique item selected from the first plurality of unique items.

25. The apparatus of claim 21 further comprising:
increasing or decreasing, via the user computing device means, the complexity of the training session according to a user performance during the training session.
